(19) United States
(12) Patent Application Publication
(10) Pub. No.: US 2025/0118848 A1
(43) Pub. Date: Apr. 10, 2025

(54) Battery Storage Tray

(71) Applicant: SK On Co., Ltd., Seoul (KR)

(72) Inventors: Dong Hyun SEO, Daejeon (KR); Jun Woo LEE, Daejeon (KR)

(21) Appl. No.: 18/906,239

(22) Filed: Oct. 4, 2024

(30) Foreign Application Priority Data
Oct. 6, 2023 (KR) 10-2023-0133425

(51) Int. Cl. H01M 50/244; H01M 50/209; H01M 50/262; H01M 50/267; H01M 50/289

(52) U.S. Cl. CPC H01M 50/244; H01M 50/262; H01M 50/267; H01M 50/289; H01M 50/209

(57) ABSTRACT

The present disclosure may provide a battery storage tray including an accommodating portion, an insert, and a fastening portion, wherein the accommodating portion includes an internal space housing the insert and one or more coupling portions provided in the internal space, the internal coupling portion including a fastening hole, the insert includes an insert coupling portion provided with a storage groove and a through-hole, and the fastening portion passes through the through-hole and is coupled with the fastening hole.

### CROSS-REFERENCE TO RELATED PATENT APPLICATION

The present application claims priority under 35 U.S.C. § 119 (a) to Korean patent application number 10-2023-0133425 filed on Oct. 6, 2023, in the Korean Intellectual Property Office, the entire disclosure of which is incorporated by reference herein.

### BACKGROUND OF THE INVENTION

### 1. Field

The present disclosure relates to a battery storage tray.

### 2. Description of the Related Art

Recently, demand for mobile devices such as smartphones, tablet PCs, and wireless earphones is increasing. In addition, as the development of electric vehicles, batteries for energy storage, robots, and satellites is carried out in a full scale, research is being actively conducted on high-performance secondary batteries that can be repeatedly charged and discharged, as an energy source.

Currently commercialized secondary batteries include nickel cadmium batteries, nickel hydrogen batteries, nickel zinc batteries, and lithium secondary batteries. Among these, lithium secondary batteries have the advantage of having almost no memory effect compared to nickel-based secondary batteries, and so they can be freely charged and discharged, have a very low self-discharge rate, and have high energy density.

Meanwhile, when manufacturing the secondary batteries, the secondary batteries were stored in a tray tailored to each shape, and the tray storing the secondary batteries was transported to each process and utilized in manufacturing and inspection processes, and the like.

### SUMMARY OF THE INVENTION

According to one aspect of the present disclosure, a battery storage tray capable of supporting various types or sizes of battery cells can be provided. In addition, according to another aspect of the present disclosure, a battery storage tray that implements an area in which battery cells are stored through a convenient assembly method can be provided.

The battery storage tray according to one aspect of the present disclosure can be widely applied in the field of electric vehicles, battery charging stations, and green technology, such solar power generation, and wind power generation using batteries. In addition, the battery storage tray according to one aspect of the present disclosure re can be applied to a manufacturing process of batteries used for eco-friendly electric vehicles, hybrid vehicles, etc. to prevent climate change by suppressing air pollution and greenhouse gas emissions.

A battery storage tray according to one aspect of the present disclosure may include an accommodating portion, an insert, and a fastening portion, wherein the accommodating portion includes an internal space housing the insert and one or more coupling portions provided in the internal space, the internal coupling portion including a fastening hole, the insert includes an insert coupling portion provided with a storage groove and a through-hole, and the fastening portion passes through the through-hole and is coupled with the fastening hole.

In a battery storage tray according to one aspect of the present disclosure, the internal coupling portion may be spaced apart from an internal wall of the accommodating portion by a predetermined gap.

In a battery storage tray according to one aspect of the present disclosure, the accommodating portion may include a plurality of internal coupling portions, and at least two of the plurality of internal coupling portions may be disposed in parallel.

In a battery storage tray according to one aspect of the present disclosure, adjacent internal coupling portions among the internal coupling portions disposed in parallel may each be spaced apart by a predetermined gap.

In a battery storage tray according to one aspect of the present disclosure, the internal coupling portions disposed in parallel may include a first internal coupling portion group provided along a first line and a second internal coupling portion group provided along a second line.

In a battery storage tray according to one aspect of the present disclosure, the first line and the second line may be parallel.

In a battery storage tray according to one aspect of the present disclosure, the first internal coupling portion group and the second internal coupling portion group may each independently include a plurality of internal coupling portions.

A battery storage tray according to one aspect of the present disclosure may further include a scale bar provide in the internal space, wherein the scale bar may be positioned between an internal coupling portion and an internal wall of an accommodating portion.

In a battery storage tray according to one aspect of the present disclosure, the insert may further include a storage frame portion including a supporting body and a frame member positioned on the supporting body, and the supporting body may be connected to the insert coupling portion, and the storage frame portion may be provided with a storage hole.

In a battery storage tray according to one aspect of the present disclosure, the insert coupling portion may be in contact with at least a part of the internal coupling portion, the insert coupling portion further including a knurled portion on a contact surface with the internal coupling portion.

In a battery storage tray according to one aspect of the present disclosure, the knurled portion may surround a through-hole.

In a battery storage tray according to one aspect of the present disclosure, the insert may include a plurality of insert coupling portions, and one or more of the insert coupling portions may be provided at each of both end portions of the supporting portion.

In a battery storage tray according to one aspect of the present disclosure, the insert may be provided in a plural number, and the plurality of inserts may be provided all in the same direction across the internal space.

In a battery storage tray according to one aspect of the present disclosure, the insert may include a first insert and a second insert, and the first insert and the second insert may have a symmetrical structure and may be positioned adjacently.

A battery storage tray according to one aspect of the present disclosure may further include a storage portion in which a battery cell is stored between a storage groove of the first insert and a storage group of the second insert.

In a battery storage tray according to one aspect of the present disclosure, the first insert and the second insert may be spaced apart, and the spaced distance may be determined by a position P₁ of a fastening portion passing through a through-hole of the first insert and a position P₂ of a fastening portion passing through a through-hole of the second insert.

In a battery storage tray according to one aspect of the present disclosure, the fastening portion may include a head portion and a fastening insert portion, and the head portion may not pass through the through-hole and the fastening insert portion may pass through the through-hole.

In a battery storage tray according to one aspect of the present disclosure, the width DA₁ of the head portion may be larger than the width DA₂ of the fastening insert portion and the width DA₃ of the through-hole, and the width DA₂ of the fastening insert portion may be smaller than or equal to the width DA₃ of the through-hole.

In a battery storage tray according to one aspect of the present disclosure, the breadth DB₁ of the head portion may be smaller than the breadth DB₃ of the through hole.

In a battery storage tray according to one aspect of the present disclosure, the height H₄ of the fastening hole may be greater than that of the height H₃ of the fastening insert portion.

According to one aspect of the present disclosure, a battery storage tray capable of supporting various types or sizes of battery cells can be provided. In addition, according to another aspect of the present disclosure, a battery storage tray that implements an area in which battery cells are stored through a convenient assembly method can be provided.

### BRIEF DESCRIPTION OF THE DRAWINGS

The drawings shown in the present disclosure are based on examples of the present disclosure, and the width, breadth, or height ratios of each component are for detailed description of the present disclosure, and these ratios may differ from the actual ratios. In addition, in the coordinate system shown in the drawings, each axis may be perpendicular to each other, the direction pointed by the arrow may be the ‘+’ direction, and the direction opposite to the direction pointed by the arrow (rotated by 180 degrees) may be the ‘-’ direction.

FIG. 1 shows an exploded perspective view schematically illustrating at least a part of a battery storage tray according to an embodiment of the present disclosure.

FIG. 2 shows a perspective view schematically illustrating at least a part of an accommodating portion of a battery storage tray according to an embodiment of the present disclosure.

FIG. 3 shows a plan view schematically illustrating at least a part of an accommodating portion of a battery storage tray according to an embodiment of the present disclosure (XY plane in FIG. 1).

FIG. 4 shows a perspective view schematically illustrating at least a part of an insert of a battery storage tray according to an embodiment of the present disclosure.

FIG. 5 shows a plan view schematically illustrating at least a part of an insert of a battery storage tray according to an embodiment of the present disclosure (XY plane in FIG. 4).

FIG. 6 shows a plan view schematically illustrating at least a part of an insert of a battery storage tray according to an embodiment of the present disclosure (an embodiment different from FIG. 5).

FIG. 7 shows a plan view schematically illustrating at least a part of an insert of a battery storage tray according to an embodiment of the present disclosure (an embodiment different from FIG. 5).

FIG. 8 shows a perspective view schematically illustrating a part of an insert of a battery storage tray according to an embodiment of the present disclosure (enlarged view of area A of FIG. 4).

FIG. 9 shows a plan view schematically illustrating at least a part of a fastening portion of a battery storage tray according to an embodiment of the present disclosure (XZ plane).

FIG. 10 shows a plan view schematically illustrating at least a part of a battery storage tray according to an embodiment of the present disclosure (XY plane).

FIG. 11 shows a perspective view schematically illustrating at least a part of a battery storage tray according to an embodiment of the present disclosure.

FIG. 12 shows a perspective view schematically illustrating at least a part of a battery storage tray according to an embodiment of the present disclosure.

FIG. 13 shows a plan view schematically illustrating at least a part of a battery storage tray according to an embodiment of the present disclosure (XY plane).

FIG. 14 shows a plan view schematically illustrating at least a part of an insert of a battery storage tray according to an embodiment of the present disclosure (XY plane).

FIG. 15 shows a plan view schematically illustrating at least a part of a battery storage tray according to an embodiment of the present disclosure (YZ plane).

FIG. 16 shows a perspective view schematically illustrating at least a part of a battery storage tray according to an embodiment of the present disclosure.

FIG. 17 shows an exploded perspective view schematically illustrating the structure of a battery cell to be stored in a battery storage tray according to an embodiment of the present disclosure.

FIG. 18 shows an exploded perspective view schematically illustrating the structure of a battery cell to be stored in a battery storage tray according to an embodiment of the present disclosure.

### DETAILED DESCRIPTION

Hereinafter, the present disclosure will be described in detail with reference to the attached drawings. This is merely illustrative, and the present disclosure is not limited to the specific embodiments described in an illustrative manner.

Among the physical properties mentioned in the present specification, in cases where the measurement temperature affects the physical properties, the properties are those measured at room temperature and normal pressure, unless otherwise specified

The term ‘room temperature,’ as used in the present specification, is a natural temperature without heating or cooling, and it may refer to, for example, any temperature in the range of 10° C. to 30° C., for example, about 15° C. or higher, about 18° C. or higher, about 20° C. or higher, about 23° C. or higher, about 27° C. or lower, or 25° C. Unless otherwise specified in the present specification, the unit of temperature is Celsius (° C.).

Among the physical properties mentioned in the present specification, in cases where the measured pressure affects the physical properties, unless otherwise specified, the physical properties are the physical properties measured at normal pressure.

The term ‘normal pressure,’ as used in the present specification, is a natural pressure without pressurization or depressurization, and an atmospheric pressure in the range of about 700 mmHg to 800 mmHg is typically referred to as normal pressure.

The term ‘a to b,’ as used in the present specification, refers to within the range between a and b including a and b. For example, including a to b parts by weight has the same meaning as including within the range of a to b parts by weight.

In the present specification, the term ‘battery’ may be used in the same meaning as ‘cell.’ In addition, the battery or cell may be a general term for a battery cell, which is a unit thereof, or a battery module or a battery pack including the battery cell.

According to one aspect of the present disclosure, a battery storage tray 10 capable of supporting various types (multiple types) or sizes of battery cells 300 can be provided. In addition, according to another aspect of the present disclosure, a battery storage tray 10 that implements an area in which battery cells 300 are stored through a convenient assembly method can be provided (see FIGS. 12 and 16).

A battery storage tray 10 according to one aspect of the present disclosure may be mainly used in an activation process during the manufacturing process of a battery cell 300. The activation process may refer to a process of activating a battery cell in an inactive state to a operable state after an electrode process and an assembly process are performed. The activation process generally involves a formation process, an aging process, and a performance inspection process, and may also include a degassing process when necessary. The battery storage tray 10 may be used throughout the above-described activation process. However, the use of the battery storage tray 10 is not limited only to the above-described activation process, but the battery storage tray may be used in other processes or conditions.

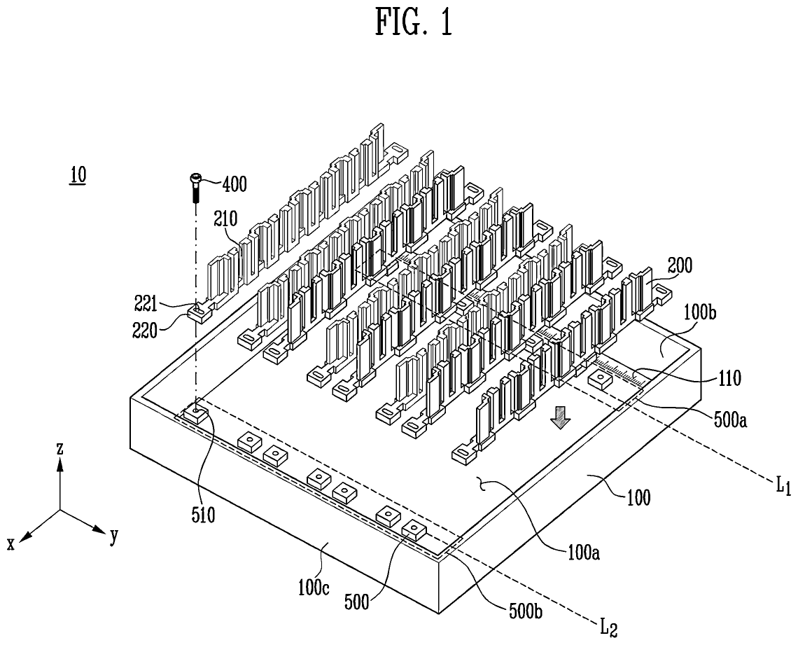

FIG. 1 shows an exploded perspective view schematically illustrating at least a part of a battery storage tray according to an embodiment of the present disclosure. An object to be stored in the battery storage tray 10 may be a battery cell 300 (see FIGS. 12 and 16).

Referring to FIG. 1, a battery storage tray 10 according to one aspect of the present disclosure may include an accommodating portion 100. In addition, the battery storage tray 10 may include an insert 200. In addition, the battery storage tray 10 may include a fastening portion 400.

Referring to FIG. 1, the insert 200 may be housed the accommodating portion 100. In other words, the accommodating portion 100 may include an internal space 100a housing the insert 200. In addition, the insert 200 may be coupled with at least some components included in the accommodating portion 100 to be fixed and housed. The insert 200 may be fixed by being coupled with at least some components included in the accommodating portion 100, or as the coupling is released, the insert may be separated. Specific details regarding this will be described later.

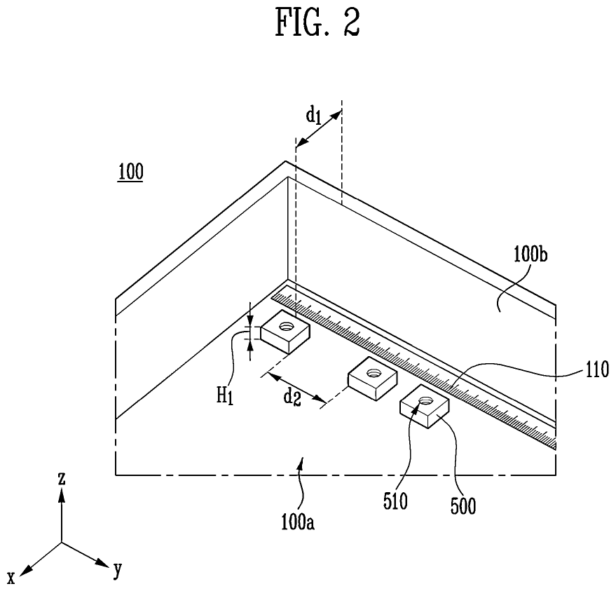

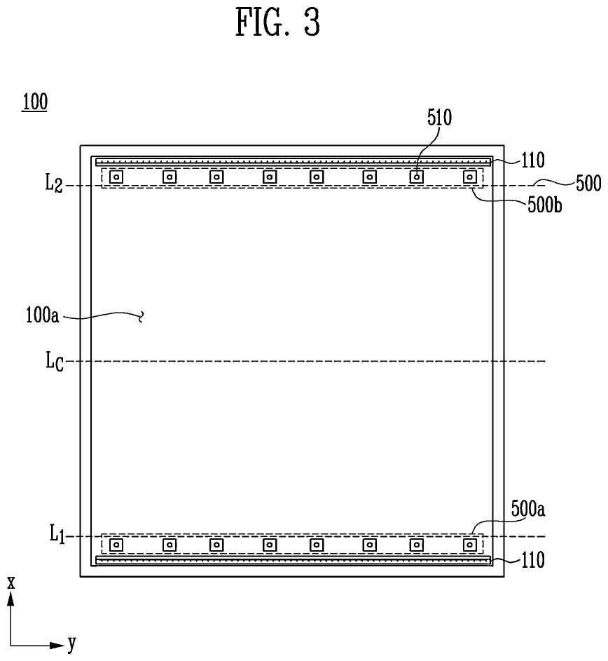

FIG. 2 shows a perspective view schematically illustrating at least a part of an accommodating portion of a battery storage tray 10 according to an embodiment of the present disclosure. FIG. 3 shows a plan view schematically illustrating at least a part of an accommodating portion 100 of a battery storage tray 10 according to an embodiment of the present disclosure (XY plane in FIG. 1). An accommodating portion 100 according to one aspect of the present disclosure will be described in detail through FIGS. 2 and 3.

An accommodating portion 100 according to one aspect of the present disclosure may include a plastic material. The structure of the accommodating portion 100 may be designed in an appropriate manner considering that an insert 200 is housed and a battery cell 300 is accommodated therein. In addition, the structure of components such as a scale bar 110 and/or an internal coupling portion 500, which may be provided in an internal space 100a of the accommodating portion 100, may also be designed in an appropriate manner. Through the above design, an accommodating portion 100 may be implemented in such manners as injection process.

Referring to FIGS. 1 and 2, an accommodating portion 100 according to one aspect of the present disclosure may include an internal space 100a housing the insert 200 therein and one or more internal coupling portions 500 provided in the internal space 100a.

The accommodating portion 100 according to one aspect of the present disclosure may have a polyhedral shape with at least one face open. For example, referring to FIGS. 1 and 2, the accommodating portion 100 may have a hexahedral shape with at least one face open. In addition, the accommodating portion 100 according to another aspect of the present disclosure may have a polyhedral shape with several faces open. Meanwhile, the accommodating portion 100 according to another aspect of the present disclosure may have a polyhedral shape in which one face is open and at least one other side (a face different from the one face) is at least partially open. For example, one of terminals 340 of a bidirectional battery cell 300, which will be described later, may protrude outward from one of the open faces, and the other of the terminals 340 may protrude outward from the other face that is at least partially open to an open part. Here, specifically, the other face that is at least partially open may mean a face facing the one face. In addition, in another example, the other surface may be locally (partially) open so that the terminal 340 may protrude outward. However, this is only an example, and the terminal 340 may be designed in various shapes as needed, as long as it may protrude outward in an appropriate manner and easily contact with a probe used for charging and discharging or inspection.

The accommodating portion 100 according to one aspect of the present disclosure may include an internal space 100a that has one face open and is formed by being surrounded by faces other than the open side as described above in order to house an insert therein. In other words, the internal space 100a may refer to a space formed by being surrounded by faces other than an open face of the accommodating portion 100 in order to house an insert 200 therein. Accordingly, the insert 200 may be housed in the internal space 100a. Here, referring to FIG. 2, the faces other than the open surface of the accommodating portion 100 may be referred to as an internal wall 100b, and the internal space 100a may refer to a space formed by being surrounded by internal walls 100b of the accommodating portion 100 in order to house an insert 200 therein.

Meanwhile, referring to FIGS. 1 and 2, the accommodating portion 100 may include an internal wall 100b and an external wall 100c. The accommodating portion 100 may have an appropriate thickness to ensure rigidity. The thickness may mean an average straight line distance between an internal wall 100b and an external wall 100c.

Meanwhile, as described above, in some cases, the accommodating portion 100 may have one face open and include the other face that is locally open so that the terminal 340 may protrude outward.

An accommodating portion 100 according to one aspect of the present disclosure may fix an insert 200 that is housed therein. In addition, the accommodating portion 100 may include one or more internal coupling portions 500 in an internal space 100a so that the insert 200 is fixed and seated within the accommodating portion 100. The insert 200 may be housed in the accommodating portion 100 through the internal coupling portion 500 and may also be fixed and seated.

Meanwhile, referring to FIGS. 2 and 3, an internal coupling portion 500 according to one aspect of the present disclosure may include a fastening hole 510. The position of the fastening hole 510 is not determined, but it may be preferable that the center of gravity of one surface of the internal coupling portion 500 coincides with the center of gravity of the fastening hole 510. In addition, the fastening hole 510 may penetrate the internal coupling portion 500, or in another example, the fastening hole may not penetrate the internal coupling portion. In addition, the fastening hole 510 may be designed in consideration of the size (a term encompassing width, breadth, and thickness (or height)) and shape of the fastening portion 400.

Referring to FIG. 1, an insert 200 according to one aspect of the present disclosure may include an insert coupling portion 220 provided with a storage groove 210 and a through-hole 221. The insert 200 may be housed in the accommodating portion 100 as the fastening portion 400 passes through the through-hole 221 and is coupled with the fastening hole 510. In addition, the insert 200 may be fixed and seated in the accommodating portion 100 according to the method described above.

In addition, referring to FIG. 1, the shape of an insert coupling portion 220 of an insert 200 according to one aspect of the present disclosure is not particularly limited, and the space to which battery cells 300 will be appropriately inserted and the number of battery cells may be considered. In addition, the through-hole 221 may be designed in consideration of the size (a term encompassing width, breadth, and thickness) and shape of the fastening portion 400.

Referring to FIG. 1, the shape of a through-hole 221 of an insert 200 according to one aspect of the present disclosure is not particularly limited as long as it allows a fastening portion 400 to appropriately pass therethrough and allows the fastening portion 400 to be coupled with a fastening hole 510 of the internal coupling portion 500. Meanwhile, for example, the fastening portion 400 may be a male screw (bolt). In addition, a fastening hole 510 of the internal coupling portion 500 may include a female screw (nut) shape. The internal coupling portion 500 may be implemented by insert injection (or insert molding) in which a plastic material and the female screw are inserted into an injection mold and injected.

Meanwhile, referring to FIG. 1, an internal coupling portion 500 according to one aspect of the present disclosure may include a shape protruding from at least one surface of an internal wall 100b of an accommodating portion 100. Referring to FIG. 1, the internal coupling portion 500 may include a shape protruding in the +Z-axis direction from one surface of an internal wall 100b. The direction in which the internal coupling portion 500 protrudes may be designed to face an open face of an accommodating portion 100. In addition, the shape of the internal coupling portion 500 is not particularly limited, and may have, for example, a cylindrical shape. In addition, the internal coupling portion 500 may include, for example, a boss structure. In addition, the protruding shape of the internal coupling portion 500 may be implemented through an injection process or the like.

Meanwhile, referring to FIG. 2, an internal coupling portion 500 according to one aspect of the present disclosure may be spaced apart from the internal wall 100b of the accommodating portion 100 by a predetermined gap d₁. In addition, referring to FIG. 2, there may be a plurality of internal coupling portions 500 according to one aspect of the present disclosure, and each of the internal coupling portions 500 may be independently spaced apart from the internal wall 100b of the accommodating portion 100 by a predetermined gap d₁. In addition, the internal wall 100b may refer to an internal wall 100b adjacent to the internal coupling portion 500, excluding an internal wall 100b from which an internal coupling portion 500 protrudes, among the plurality of internal walls 100b. Specifically, the adjacent internal wall 100b may refer to an internal wall 100b that faces and is positioned closest to the internal coupling portion 500 among the internal walls 100b provided in the accommodating portion 100.

In addition, referring to FIGS. 1 and 2, the gap d₁ may be determined depending on the shape or size of an insert coupling portion 220 of an insert 200. Since the internal coupling portion 500 is positioned to be spaced apart from an internal wall 100b by predetermined gap d₁, it is possible to respond to various types (multiple types) or sizes of battery cells 300 and to provide a battery storage tray 10 that implements an area where the battery cells 300 are stored, through a convenient assembly method.

Referring to FIGS. 1 and 2, as described above, the accommodating portion 100 may include a plurality of internal coupling portions 500. In other words, the accommodating portion 100 may include a plurality of internal coupling portions 500 provided in an internal space 100a. The number of internal coupling portions 500 is determined by the size and number of inserts 200 and battery cells 300 to be accommodated, and is not limited to a specific range.

Referring to FIGS. 1 and 2, each of the plurality of internal coupling portions 500 may have the same or different width, breadth, and height H₁. Here, the height H₁ of the internal coupling portion 500 may refer to the height of a protruding area, that is, the protruding length from an internal wall 100b. A plurality of internal coupling portions 500 according to one aspect of the present disclosure may all have the same height H₁. Here, being the same means being substantially the same, and may mean not only exactly the same numerical values but also cases where the numerical values are different but the difference is within 10%. In addition, the height H₁ may mean a distance between a lowest position and a highest position based on the Z-axis direction. When the heights H₁ of the plurality of internal coupling portions 500 are made the same, more coupling stability may be ensured when an insert 200 is housed in an accommodating portion 100.

In addition, the height H₁ of the internal coupling portion 500 may have a size of 1% or more, 3% or more, or 5% or more of the height of the accommodating portion 100 in order to ensure the direction of a terminal 340 of a battery cell 300, the protruding length of the terminal 340, and the coupling stability of an insert 200. The height of the accommodating portion 100 may refer to the distance between a lowest position and a highest position of the accommodating portion 100 based on the Z-axis direction.

Referring to FIGS. 1 and 2, at least two of the plurality of internal coupling portions 500 may be disposed in parallel. In addition, a battery storage tray 10 according to an embodiment of the present disclosure may include a plurality of internal coupling portions 500, and the plurality of internal coupling portions 500 may include internal coupling portions 500 disposed in parallel. In addition, among the internal coupling portions 500 disposed in parallel, internal coupling portions 500 that are adjacent to each other may be spaced apart from each other by a predetermined gap d₂. The gap d₂ may be the same or different. Here, being the same means being substantially the same, and may mean not only exactly the same numerical values but also cases where the numerical values are different but the difference is within 10%.

In addition, referring to FIGS. 1 and 2, the gap d₂ may be determined depending on the shape or size of an insert coupling portion 220 of an insert 200. As at least two of the plurality of internal coupling portions 500 are disposed in parallel, and the internal coupling portions 500 that are adjacent to each other are spaced apart by a predetermined gap d₂, a battery storage tray 10 capable of supporting various types (multiple types) or sizes of battery cells 300 and implementing an area in which battery cells 300 are stored through a convenient assembly method can be provided.

Referring to FIGS. 1 to 3, in a battery storage tray 10 according to one aspect of the present disclosure, the internal coupling portions 500 disposed in parallel may include a first internal coupling portion group 500a provided along a first line L₁ and a second internal coupling portion group 500b provided along a second line L₂. Here, the ordinal numbers written in front of the first line L₁ and the second line L₂ are simply added for distinction, regardless of the order or importance. In addition, the ordinal numbers written in front of the first internal coupling portion group 500a and the second internal coupling portion group 500b are simply added for distinction, regardless of the order or importance, for correspondence with the first line L₁ and the second line L₂.

In addition, the internal coupling portion group being provided along a specific line may mean that the specific line passes through at least a partial area of each internal coupling portion 500 constituting the internal coupling portion group. In addition, referring to FIGS. 1 and 3, the internal coupling portion group being provided along a specific line means that the specific line is in contact with at least a partial area of each internal coupling portion 500 constituting the internal coupling portion group. In addition, the specific line may be positioned close to the inside of an accommodating portion 100 while being in contact with all of the internal coupling portions 500 constituting the internal coupling portion group. For example, referring to FIG. 3, the first line L₁ may be positioned close to the inside of an accommodating portion 100 while being in contact with all of the internal coupling portions 500 constituting the first internal coupling portion group 500a (positioned closer to the +X-direction). In addition, referring to FIG. 3, the second line L₂ may be positioned located close to the inside of an accommodating portion 100 while being in contact with all of the internal coupling portions 500 constituting the second internal coupling portion group 500b (positioned closer to the −X-direction).

Meanwhile, the first line L₁ and the second line L₂ may be a straight line or a curved line, and it may be preferable that they are a straight line. In addition, the first line L₁ and the second line L₂ may be parallel to an internal wall 100b adjacent to each of the internal coupling portion groups. Referring to FIGS. 1 and 3, the first line L₁ may be parallel to an internal wall 100b adjacent to a first internal coupling portion group 500a provided along the first line L₁. In addition, referring to FIGS. 1 and 3, the second line L₂ may be parallel to an internal wall 100b adjacent to a second internal coupling portion group 500b provided along the second line L₂.

In addition, the first line L₁ and the second line L₂ may refer to an imaginary line formed in an internal space 100a of an accommodating portion 100, specifically, on an internal wall 100b. In other words, the internal coupling portions 500 disposed in parallel may include a group of internal coupling portions each provided along a plurality of imaginary lines. Meanwhile, the internal coupling portion 500 is not limited to the first line L₁ and the second line L₂, but may include an nth internal coupling portion group according to an nth line (Lₙ, n is an integer of 3 or more).

Referring to FIG. 3, the first line L₁ and the second line L₂ may be parallel. Since the first line L₁ and the second line L₂ are parallel, a first internal coupling portion group 500a and a second internal coupling portion group 500b may be positioned in parallel with each other. When the internal coupling portion group is positioned in this manner, more stability may be ensured when an insert 200 is housed in an accommodating portion 100.

Meanwhile, an insert 200, which will be described later, may be disposed across an internal space 100a of an accommodating portion 100. One or more selected from the group consisting of the first line L₁ and the second line L₂ may be perpendicular to the direction in which the insert 200 crosses. For example, referring to FIG. 1, the insert 200 may be provided across an internal space 100a in the X-axis direction, and one or more selected from the group consisting of the first line L₁ and the second line L₂ may be formed in the Y-axis direction perpendicular to the X-axis.

Referring to FIGS. 1 and 3, the first internal coupling portion group 500a and the second internal coupling portion group 500b may each independently include a plurality of internal coupling portions 500. The number of internal coupling portions 500 included in each of the first internal coupling portion group 500a and the second internal coupling portion group 500b may be the same or different. In addition, the number of internal coupling portions 500 included in each of the first internal coupling portion group 500a and the second internal coupling portion group 500b may be designed in consideration of the number, type, or size of battery cells 300 to be stored.

Referring to FIG. 3, it may be preferable that the number of internal coupling portions 500 included in the first internal coupling portion group 500a and the second internal coupling portion group 500b is the same. In addition, for the first internal coupling portion group 500a and the second internal coupling portion group 500b, the positional relationship of at least some of the included internal coupling portions 500 may be symmetrical with respect to a symmetrical line Lc connecting parts corresponding to ½ positions of the vertical distance between the first line L₁ and the second line L₂. In addition, referring to FIG. 3, for the first internal coupling portion group 500a and the second internal coupling portion group 500b, the positional relationship of all the included internal coupling portions 500 may be symmetrical with respect to the symmetrical line Lc. As a result, a battery storage tray 10 capable of supporting various types (multiple types) or sizes of battery cells 300 and implementing an area in which battery cells 300 are stored through a convenient assembly method can be provided.

Referring to FIGS. 1 to 3, a battery storage tray 10 according to one aspect of the present disclosure may include a scale bar 110. The scale bar 110 may be provided in an internal space 100a. In addition, referring to FIGS. 1 to 3, the scale bar 110 may be provided on an internal wall 100b from which the internal coupling portion 500 protrudes. The scale of the scale bar 110 may be appropriately designed in consideration of the type and size of battery cells 300 to be stored. The scale may refer to a certain breadth between graduations. In addition, the scale bar 110 may be helpful in housing an insert 200 in an internal space 100a and disposing the insert 200 in consideration of the type and size of battery cells 300 to be stored. Through the scale bar 110, in consideration of the size of a target battery cell 300 and the like, the position and distance of the housed insert (when a plurality of inserts 200 are included, a distance between inserts adjacent to each other) and the like may be measured, and the insert 200 may be appropriately disposed.

Referring to FIGS. 1 to 3, the scale bar 110 may be positioned between an internal coupling portion 500 and an internal wall 100b of an accommodating portion 100. In addition, the internal wall 100b may refer to an internal wall 100b adjacent to the internal coupling portion 500, excluding an internal wall 100b on which an internal coupling portion 500 protrudes, among a plurality of internal walls 100b. Specifically, the adjacent internal wall 100b may refer to an internal wall 100b that faces and is positioned closest to the internal coupling portion 500 among the internal walls 100b provided in the accommodating portion 100.

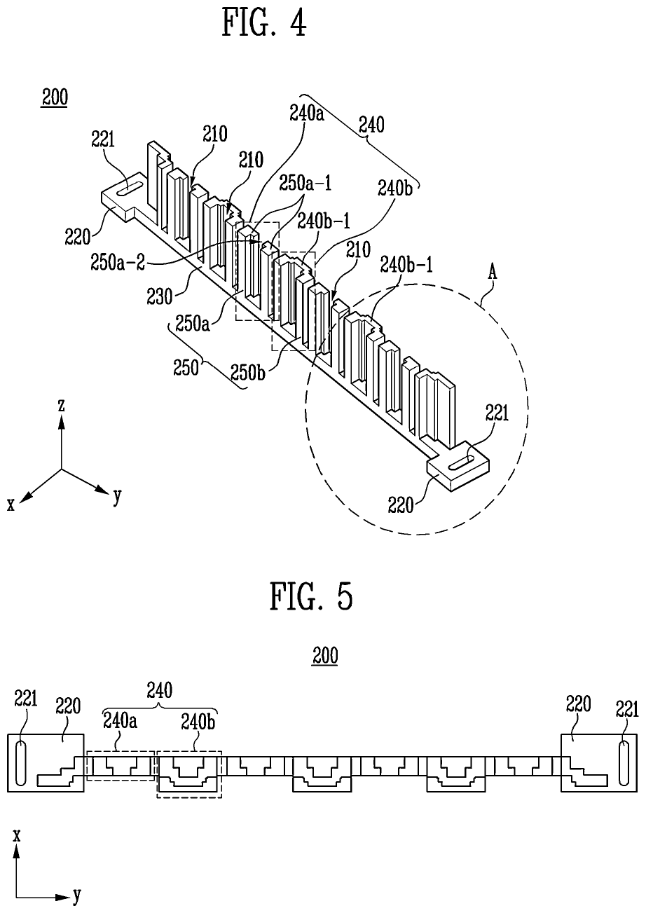

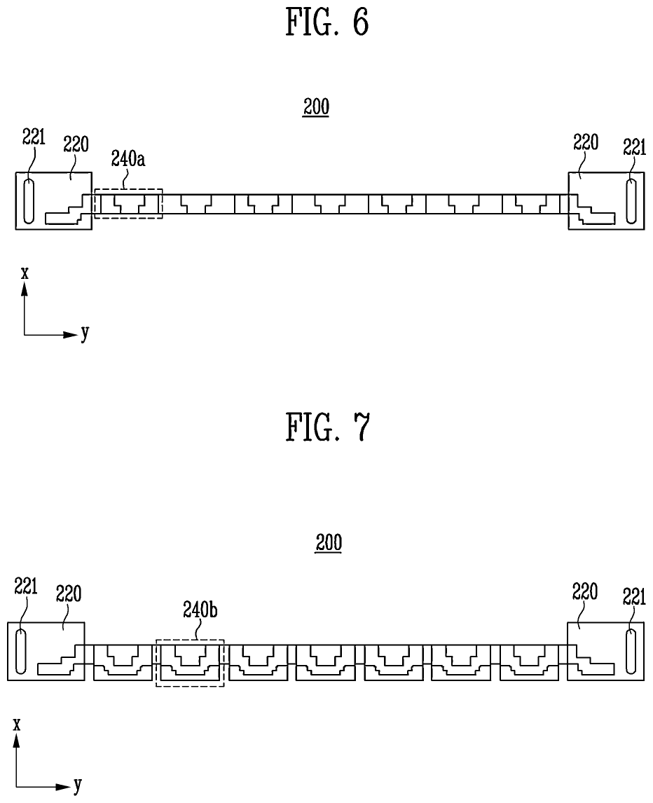

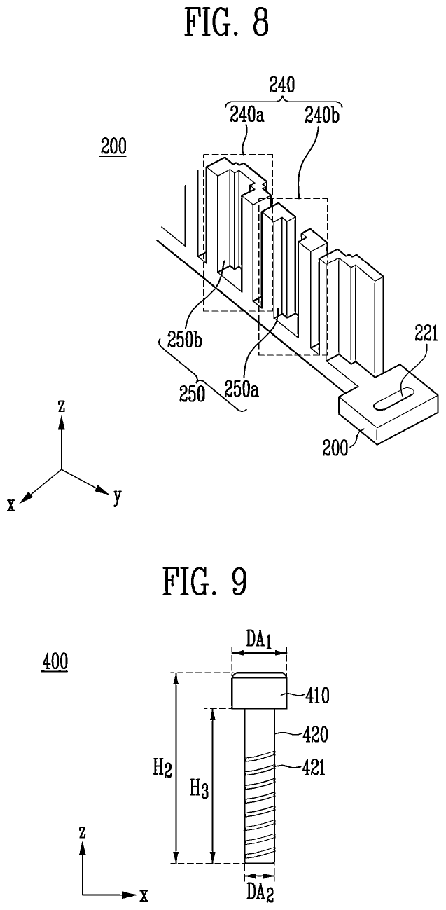

FIG. 4 shows a perspective view schematically illustrating at least a part of an insert 200 of a battery storage tray 10 according to an embodiment of the present disclosure. FIG. 5 shows a plan view schematically illustrating at least a part of an insert 200 of a battery storage tray 10 according to an embodiment of the present disclosure (XY plane in FIG. 4). FIGS. 6 and 7 show plan views schematically illustrating at least a part of an insert 200 of a battery storage tray 10 according to an embodiment of the present disclosure (an embodiment different from FIG. 5). FIG. 8 shows a perspective view schematically illustrating a part of an insert 200 of a battery storage tray 10 according to an embodiment of the present disclosure (enlarged view of area A of FIG. 4).

A battery cell 300 may be stored in an insert 200 of a battery storage tray 10 according to one aspect of the present disclosure (see FIG. 12). In the battery storage tray 10, an insert 200 is coupled to an accommodating portion 100 to create an area in which battery cells 300 may be stored, and battery cells 300 may be stored in the an area in which battery cells may be stored (a battery storage portion 260, which will be described later, see FIG. 12). The battery storage tray 10 storing battery cells 300 in this way may be used mainly in an activation process and the like.

An insert 200 according to one aspect of the present disclosure may include a plastic material. The structure of the insert 200 may be designed in an appropriate manner in consideration of the type or size of battery cells 300 to be stored. In addition, the structure of components such as an insert coupling portion 220 of an insert 200, which will be described later, may also be designed in an appropriate manner. Through the above design, an insert 200 may be implemented in such a manner as an injection process. The insert 200 may be formed into an appropriate shape and structure in consideration of the size of battery cells 300 and the like, and the structure of the insert 200 which will be described later is only an example, and the structure of the insert is not limited thereto.

An insert 200 according to one aspect of the present disclosure may be provided across an internal space 100a of an accommodating portion 100 and may be coupled to the accommodating portion 100. For example, referring to FIG. 1, the insert 200 may be provided in the X-axis direction across the internal space 100a.

An insert 200 according to one aspect of the present disclosure may include a storage groove 210. The storage groove 210 may refer to a groove in which at least a part of battery cells 300 may be stored. In addition, when a plurality of inserts 200 are disposed and combined, the storage groove 210 may allow the battery storage tray 10 to be provided with a battery storage portion 260 in which the battery cells 300 may be stored (see FIG. 12).

At least a part of an insert 200 according to one aspect of the present disclosure may be positioned on an internal coupling portion 500. For example, referring to FIG. 1, the insert 200 may move in the −Z-direction and comes into contact with an internal coupling portion 500 protruding from one surface of an internal wall 100b (for example, protruding in the +Z-direction). The insert 200 may be positioned on the internal coupling portion 500 while being in contact with the internal coupling portion 500.

In addition, at least a part of insert coupling portions 220 of an insert 200 according to one aspect of the present disclosure may be positioned on an internal coupling portion 500. For example, referring to FIG. 1, the insert 200 may move in the −Z-direction, and an internal coupling portion 500 protruding from one surface of an internal wall 100b (for example, protruding in the +Z-direction) and at least a part of the insert coupling portion 220 of the insert 200 may be in contact. In other words, the insert coupling portion 220 may be in contact with the internal coupling portion 500 at least partially.

In addition, an insert 200 according to one aspect of the present disclosure may be positioned such that at least a part of a fastening hole 510 of an internal coupling portion 500 is exposed through a through-hole 221 of an insert coupling portion 220. In other words, the through-hole 221 and the fastening hole 510 may face each other at least partially. In addition, the size of the area where the fastening hole 510 is exposed by the through-hole 221 or the size of the area where the through-hole 221 and the fastening hole 510 face each other may be designed in consideration of the size (a term encompassing width, breadth, and thickness) and shape of a fastening portion 400.

As the fastening portion 400 passes through the through-hole 221 and is coupled with the fastening hole 510, an insert 200 according to one aspect of the present disclosure may be housed in the accommodating portion 100, and specifically, it may be fixed to an internal space 100a. Conversely, as the coupled fastening portion 400 is decoupled from the fastening hole 510, the insert 200 may be separated from the accommodating portion 100.

An insert 200 according to one aspect of the present disclosure may include a supporting body 230. Referring to FIG. 4, the insert 200 may include a supporting body 230 that may be connected to or support other components. The shape of the supporting body 230 is not particularly limited, but it may be designed in consideration of the shape of an accommodating portion 100, components that are connected to or supported by the supporting body, and the shape and number of a battery storage portion 260 (see FIG. 12), which will be described later. For example, the supporting body 230 may have a long shape in the longitudinal direction, and although not being limited thereto, it may have, for example, a beam or pipe shape. In other words, referring to FIG. 4, the supporting body 230 may have a long shape in the longitudinal direction of the Y-axis.

Referring to FIG. 4, the supporting body 230 may be connected to an insert coupling portion 220. The insert coupling portion 220 may be part of the supporting body 230, or may be connected to the supporting body 230 through a connecting means. The connecting means is not particularly limited, but may be implemented and designed using an injection process or the like described below. In addition, the insert coupling portion 220 being a part of the supporting body 230 may mean that they are integrated. In addition, when the structure of the insert 200 is implemented through an injection process or the like, the insert coupling portion 220 and the supporting body 230 may be integrated.

The insert coupling portion 220 may be provided at an appropriate position in the supporting body 230 to utilize space when the insert 200 is coupled to an accommodating portion 100 and a battery cell 300 is stored. In addition, the insert 200 may include a plurality of insert coupling portions 220 for stable coupling with an accommodating portion 100.

Referring to FIGS. 1 and 4, an insert 200 according to one aspect of the present disclosure may include one or more insert coupling portions 220 provided at each of both end portions of the supporting body 230. In other words, one or more of the insert coupling portions 220 may be provided at each of both end portions of the supporting portion 230. In addition, the insert 200 may include one or more insert coupling portions 220 connected to each of both end portions of the supporting body 230. The connection may be implemented through an injection process or the like, as described above.

Meanwhile, referring to FIGS. 1 and 4, in an insert 200 according to one aspect of the present disclosure, there may be substantially no step between the supporting body 230 and the insert coupling portion 220. The fact that there is substantially no step may mean that there is no step or even when there is a step, it is to a degree of 5% or less or 1% or less of the height of the supporting body 230. When a step between the supporting body 230 and the insert coupling portion 220 is minimized, it may be advantageous in terms of manufacturing process.

Referring to FIGS. 4 and 5, an insert 200 according to one aspect of the present disclosure may include a storage frame portion 240 including at least one frame member 250 positioned on the supporting body 230. At least a part of the frame member 250 may be bent depending on the case. The insert 200 may include one or a plurality of storage frame portions 240. Meanwhile, the frame member 250 may be positioned on an insert coupling portion 220. In addition, the frame member 250 may be positioned on one or more selected from the group consisting of an insert coupling portion 220 and a supporting body 230.

Referring to FIG. 4, the insert 200 may include a storage frame portion 240 implemented as the frame member 250. In other words, the storage frame portion 240 may include a frame member 250. Meanwhile, the shape of the storage frame portion 240 may be determined according to the shape of the frame member 250. In addition, when the frame member 250 is bent at least partially, the shape of the storage frame portion 240 may be determined according to the bent shape of the frame member 250.

Referring to FIG. 4, the insert 200 may include a plurality of frame members 250, and a plurality of storage frame portions 240 may be implemented using the plurality of frame members 250. In other words, the insert 200 may include a plurality of frame members 250 and, accordingly, may include a plurality of storage frame portions 240.

Meanwhile, referring to FIG. 4, the supporting body 230 may be connected to a frame member 250. The frame member 250 may be a part of the supporting body 230, or may be connected to the supporting body 230 through a connecting means. Here, the connecting means is not particularly limited, but may be implemented and designed through an injection process or the like described below. In addition, the frame member 250 being a part of the supporting body 230 may mean that they are integrated. In addition, when the structure of the insert 200 is implemented through an injection process or the like, the frame member 250 and the supporting body 230 may be integrated.

Referring to FIG. 4, a storage frame portion 240 of an insert 200 according to one aspect of the present disclosure may be provided with a storage groove 210 through the structure of a frame member 250. Referring to FIG. 4, a storage frame portion 240 may include one or a plurality of frame members 250, and may be provided with various shapes of storage grooves 210 depending on the structure of the frame member 250.

Referring to FIG. 4, when each frame member 250 provided on a supporting body 230 is bent at least partially, the number of times of bending and directions of bending of the frame member 250 may be each independent. The number of times of bending and directions of bending of the frame member 250 may be designed in an appropriate manner in consideration of the type, size, and the like of battery cells 300 to be accommodated in the insert 200.

Meanwhile, referring to FIG. 4, an insert 200 according to one aspect of the present disclosure may include a plurality of storage frame portions 240, and the structure and shape of each storage frame portion 240 may be independent. Referring to FIGS. 4 and 8, the storage frame portion 240 may include a first storage frame portion 240a including a plurality of first frame members 250a and a second storage frame portion 240b including one second frame member 250b. In other words, a frame member 250 may include one or more selected from the group consisting of a plurality of first frame members 250a and a single second frame member 250b. Here, the ordinal numbers written in front of the first frame member 250a and the second frame member 250b are simply added for distinction, regardless of the order or importance.

Referring to FIGS. 4 and 8, in an insert 200 according to one aspect of the present disclosure, the first storage frame portion 240a may include a storage groove 210 formed by a plurality of first frame members 250a.

Referring to FIG. 4, the first storage frame portion 240a may be provided with a plurality of first frame members 250a spaced apart from each other. The first frame member 250a may be bent at least partially. In addition, the adjacent first frame members 250a may be disposed so that each bent part faces each other. Referring to FIG. 4, the bent part may be a protruding part 250a-1. Referring to FIG. 4, when the protruding parts 250a-1 of first frame members 250a are disposed to face each other in this manner, a storage groove 210 may be naturally formed. In addition, when a plurality of first frame members 250a are spaced apart from each other and protruding parts 250a-1 of each first frame member 250a are disposed to face each other, a passing area 250a-2 may be formed between the protruding parts 250a-1.

In the above, a first storage frame portion 240a was defined as a storage frame portion 240 including a plurality of first frame members 250a, but a storage frame portion 240 in which a passing area 250a-2 is formed may be referred to as a first storage frame portion 240a, as described above. In addition, a spacing distance between the plurality of first frame members 250a may be determined depending on the shape, size, and the like of battery cells 300.

Referring to FIG. 4, in an insert 200 according to one aspect of the present disclosure, the second storage frame portion 240b may include a storage groove 210 by one second frame member 250b. Referring to FIG. 4, the second storage frame portion 240b may be provided with one second frame member 250b. The second frame member 250b may be bent at least partially. In addition, the second frame member 250b may be bent multiple times. When the second frame member 250b is bent at least partially, the positions and the number of times bending of the second frame member 250b may be determined depending on the shape, size, and the like of battery cells 300. In some cases, the second frame member 250b may be bent multiple times to form a storage groove 210 in which at least a part of the battery cells 300 may be stored.

In addition, the second storage frame 240b may include a protruding portion 240b-1 that protrudes relative to a first storage frame 240a due to the bent shape of the second frame member 250b. Referring to FIG. 4, the second storage frame 240b includes a protruding portion 240b-1 that protrudes relative to the first storage frame 240a, and the protruding portion 240b-1 protrudes in the −X direction.

In addition, referring to FIG. 4, the second frame member 250b may be bent multiple times to form a storage groove 210. In addition, the second frame member 250b may not include components such as the passing area 250a-2. In the above, a second storage frame portion 240b was defined as a storage frame portion 240 including one second frame member 250b, but, unlike a first storage frame portion 240a, a storage frame portion 240 that does not include components such as a passing area 250a-2 may be referred to as a second storage frame portion 240b, as described above.

Meanwhile, referring to FIG. 4, the insert 200 according to one aspect of the present disclosure may include a first storage frame portion 240a and a second storage frame portion 240b. In addition, the insert 200 may include a first storage frame portion 240a and a second storage frame portion 240b, and may include a structure in which the first storage frame portion 240a and the second storage frame portion 240b are sequentially disposed. In other words, the insert 200 may include a structure in which, in a supporting body 230 having a long shape in the longitudinal direction, a first storage frame portion 240a and a second storage frame portion 240b are spaced apart from each other and sequentially disposed along the longitudinal direction of the supporting body 230. Here, the spaced distance of the first storage frame portion 240a and the second storage frame portion 240b may be determined depending on the shape, size, and the like of battery cells 300.

Referring to FIG. 4, there may be a plurality of structures in which the first storage frame portion 240a and the second storage frame portion 240b are spaced apart from each other and sequentially disposed. Here, the spaced distance between the first storage frame portion 240a and the second storage frame portion 240b may be each independent, and for example, the spaced distances may be different from or the same as each other. Considering space efficiency, there may be a plurality of structures in which the first storage frame portion 240a and the second storage frame portion 240b are spaced apart from each other and sequentially disposed, and each of the spaced distances between the first storage frame portion 240a and the second storage frame portion 240b may be the same.

In addition, referring to FIG. 4, there may be a plurality of structures in which the first storage frame portion 240a and the second storage frame portion 240b are spaced apart from each other and sequentially disposed, and there may be an appropriate spaced distance between the sequentially disposed structures. Here, each of the spaced distances may be each independent, and for example, each of the separation distances may be different from or the same as each other. Considering space efficiency, each of the spaced distances between the sequentially disposed structures may be the same.

Specifically, for example, referring to FIG. 4, the supporting body 230 has a long shape in the longitudinal direction of the Y-axis, and the insert 200 is viewed along the longitudinal direction of the Y-axis, it includes a plurality of structures in which a first storage frame portion 240a—and a second storage frame portion 240b are sequentially disposed. In addition, the insert 200 may consecutively include structures in which a first storage frame portion 240a—and a second storage frame portion 240b are sequentially disposed. Here, the meaning of ‘consecutively including’ may be that the structure in which a first storage frame portion 240a—and a second storage frame portion 240b are sequentially disposed is repeated at least twice or more. For example, the structure may be repeated as a first storage frame part 240a—a second storage frame part 240b—a first storage frame part 240a—a second storage frame part 240b—and a first storage frame part 240a.

In addition, each of the spaced distances between a first storage frame portion 240a—and a second storage frame portion 240b may be independent, or referring to FIG. 4, it may be the same.

Meanwhile, the insert 200 may include a plurality of structures in which the first storage frame portion 240a and the second storage frame portion 240b are spaced apart from each other and sequentially disposed, and the sequentially disposed structures may be included consecutively. Here, each of the spaced distances between the sequentially disposed structures may be independent, or referring to FIG. 4, it may be the same. In addition, the insert 200 may include a structure in which a first storage frame portion 240a—and a second storage frame portion 240b are sequentially disposed or consecutively include structures in which a first storage frame portion 240a—and a second storage frame portion 240b are sequentially disposed, but it does not necessarily begin with a first storage frame portion 240a or end with a second storage frame portion 240b. The structure of the insert 200 may be determined depending on the shape, size, and the like of battery cells 300.

Referring to FIG. 4, an insert 200 includes a structure in which a first storage frame portion 240a-a second storage frame portion 240b-a first storage frame portion 240a-a second storage frame portion 240b-a first storage frame portion 240a-a second storage frame portion 240b—and a first storage frame portion 240a are sequentially disposed. In other words, referring to FIG. 4, the insert 200 may include a structure in which a first storage frame portion 240a—and a second storage frame portion 240b are sequentially disposed, and may also include structures in which these are sequentially disposed.

As described above, when the insert 200 includes a structure in which a first storage frame portion 240a—and a second storage frame portion 240b are sequentially disposed, a battery storage tray 10 capable of supporting various types (multiple types) or sizes of battery cells 300 and implementing an area in which battery cells 300 are stored through a convenient assembly method can be provided.

Meanwhile, when the insert 200 consecutively includes structures in which a first storage frame portion 240a—and a second storage frame portion 240b are sequentially disposed, a storage groove 210 may be provided by each protruding portion 240b-1 of one second storage frame portion 240b and the other second storage frame portion 240b adjacent thereto. Referring to FIG. 4, a storage groove 210 in which at least a part of battery cells 300 may be stored may be provided between adjacent second storage frame portions 240b including protruding portions 240b-1 protruding in the −X direction.

In other words, the insert 200 may include a storage frame portion 240 that is in itself provided with a storage groove 210 through a frame member 250. For example, a first storage frame portion 240a may be provided with a storage groove 210 through a plurality of first frame members 250a, and a second storage frame portion 240b may be provided with a storage groove 210 through one second frame member 250b. In addition, when the first storage frame portions 240a and the second storage frame portion 240b are appropriately disposed, the insert 200 may be provided with a storage groove 210 between protruding portions 240b-1 between the second storage frame portions 240b. The insert 200 may be implemented through an injection process or the like, as described above.

An insert 200 according to one aspect of the present disclosure may include an insert coupling portion 220 having an appropriate shape in consideration of the shape and size of an internal coupling portion 500. Referring to FIG. 4, the insert coupling portion 220 may be provided at each of both end portions of the supporting body 230.

Referring to FIGS. 5 and 8, in an insert 200 according to one aspect of the present disclosure, an insert coupling portion 220 may include a through-hole 221. The through-hole 221 may penetrate the insert coupling portion 220. At least a part of the above-described fastening portion 400 may pass through the through-hole 221. The shape and number of the through-holes 221 are not particularly limited, and may be designed in consideration of the number and shape of fastening portions 400, the size of an internal coupling portion 500, the shape of a fastening hole 510, and the like.

Meanwhile, referring to FIGS. 5 to 7, an insert 200 according to one aspect of the present disclosure may include one or more selected from the group consisting of a first storage frame portion 240a and a second storage frame portion 240b.

Referring to FIG. 6, an insert 200 according to one aspect of the present disclosure may include a first storage frame portion 240a. In addition, referring to FIG. 6, the insert 200 may include a plurality of first storage frame portions 240a. Here, the spaced distance between adjacent first storage frame portions 240a may be determined depending on the shape, size, and the like of battery cells 300.

Referring to FIG. 6, the insert 200 may include a plurality of first storage frame portions 240a, and the spaced distances between the adjacent first storage frame portions 240a may be each independent. For example, each of the spaced distances may be different from or the same as each other. Considering space efficiency and ease of contact with a probe used for charging and discharging or inspection, each of the spaced distances between the adjacent first storage frame portions 240a may be the same. The insert 200 may be implemented through an injection process or the like, as described above.

Referring to FIG. 7, an insert 200 according to one aspect of the present disclosure may include a second storage frame portion 240b. In addition, referring to FIG. 7, the insert 200 may include a plurality of second storage frame portions 240b. Here, the spaced distances between adjacent second storage frame portions 240b may be determined depending on the shape, size, and the like of battery cells 300.

Referring to FIG. 7, the insert 200 may include a plurality of second storage frame portions 240b, and the spaced distances between the adjacent second storage frame portions 240b may be each independent. For example, each of the spaced distances may be different from or the same as each other. Considering space efficiency and ease of contact with a probe used for charging and discharging or inspection, each of the spaced distances between the adjacent second storage frame portions 240b may be the same. The insert 200 may be implemented through an injection process or the like, as described above.

FIG. 9 shows a plan view schematically illustrating at least a part of a fastening portion 400 of a battery storage tray 10 according to an embodiment of the present disclosure (XZ plane). Referring to FIG. 1, the fastening portion 400 may pass through the through-hole 221 provided in an insert coupling portion 220 of an insert 200. In addition, the fastening portion 400 may be coupled to a fastening hole 510 included in the internal coupling portion 500. In addition, the fastening portion 400 may be coupled with the fastening hole 510 in a state of having passed through the through-hole 221. Through the fastening portion 400, the insert 200 may be housed in the accommodating portion 100.

Referring to FIGS. 1 and 9, at least a part of the fastening portion 400 may pass through the through-hole 221. In addition, in another example, only a part of the fastening portion 400 may pass through the through-hole 221. In addition, only a part of the fastening portion 400 may pass through the through-hole 221, and at least a part of the part that has passed through the through-hole 221 may be coupled with the fastening hole 510. When only a part of the fastening portion 400 passes through the through-hole 221, more coupling stability may be ensured than when an insert 200 is housed in an accommodating portion 100.

Referring to FIG. 9, the fastening portion 400 may include a head portion 410 and a fastening insert portion 420. In addition, the head portion 410 may not pass through the through-hole 221. In addition, the fastening insert portion 420 may pass through the through-hole 221. In the above, the part of the fastening portion 400 that passes through the through-hole 221 may be a fastening insert portion 420, and the part of the fastening portion 400 that does not pass therethrough may be a head part 410.

Referring to FIG. 9, the width DA₁ of the head portion 410 may be larger than the width DA₂ of the fastening insert portion 420. In another example, the cross-sectional area of the head portion 410 may be larger than the cross-sectional area of the fastening insert portion 420, and here, the cross-sectional area may refer to a plane that appears when the fastening portion 400 is cut on the XY-plane in FIG. 1.

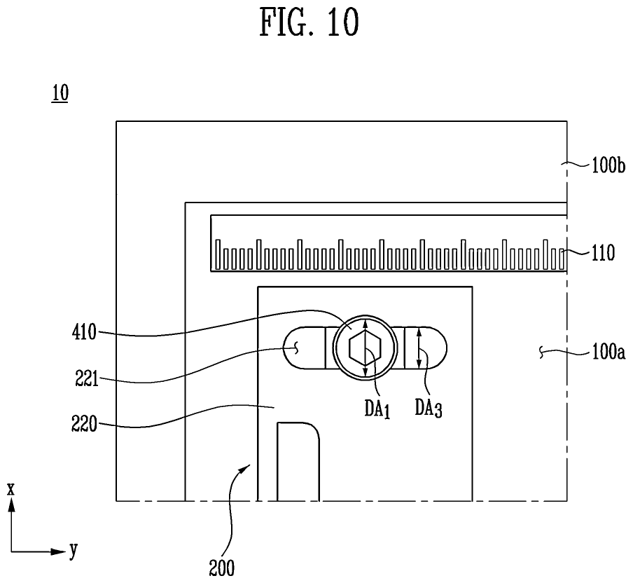

In addition, as will be described later, the width DA₁ of the head portion 410 may be larger than the width DA₃ of the through-hole 221 (see FIG. 10). In addition, the width DA₁ of the head portion 410 may be larger than the width DA₂ of the fastening insert portion 420 and the width DA₃ of the through-hole 221. Meanwhile, in another example, the cross-sectional area of the head portion 410 may be larger than the cross-sectional area of the through-hole 221, and here, the cross-sectional area may refer to a plane that appears when the fastening portion 400 or the internal coupling portion 500 is cut on the XY-plane in FIG. 1.

In addition, as will be described later, the width DA₂ of the fastening insert portion 420 may be smaller than or equal to the width DA₃ of the through-hole 221 (see FIG. 10). Meanwhile, in another example, the cross-sectional area of the fastening insert portion 420 may be smaller than or equal to the cross-sectional area of the through-hole 221, and here, the cross-sectional area may refer to a plane that appears when the fastening portion 400 or the internal coupling portion 500 is cut on the XY-plane in FIG. 1.

When the relationship with respect to the width or cross-sectional area between the head portion 410, the fastening insert portion 420, and the through-hole 221 of the fastening portion 400 is designed as described above, more coupling stability may be ensured than when an insert 200 is housed in an accommodating portion 100.

Referring to FIGS. 2 and 9, the fastening portion 400 may have an appropriate height H₂. The height H₂ of the fastening portion 400 may be smaller than, equal to, or greater than the height H₁ of the internal coupling portion 500. The height H₂ of the fastening portion 400 is not particularly limited as long as fastening stability may be ensured when an insert 200 is housed in an accommodating portion 100. In particular, there are cases where the fastening portion 400 has authorized specifications, and a fastening portion having appropriate specifications that allow for ensuring coupling stability when the insert 200 is housed in an accommodating portion 100 may be used. For example, as will be described later, the fastening portion 400 may be a screw, and the fastening portion 400 may have a size according to known screw specifications.

In addition, referring to FIGS. 2 and 9, a fastening insert portion 420 of the fastening portion 400 may have an appropriate height H₃. The height H₃ of the fastening insert portion 420 may be 50% or more than the height H₂ of the fastening portion 400. In other words, the height ratio (H₃/H₂) may be 0.5 or more and may be less than 1. In this way, when the fastening insert portion 420 has an appropriate height H₃, more coupling stability may be ensured than when an insert 200 is housed in an accommodating portion 100.

In addition, referring to FIG. 9, the fastening portion 400 may include a screw thread 421. In addition, the screw thread 421 may be provided in the fastening insert portion 420. The screw thread 421 may strengthen a coupling force when the fastening portion 400 is coupled with a fastening hole 510, thereby ensuring more coupling stability than when an insert 200 is housed in an accommodating portion 100. Meanwhile, the fastening hole 510 may have a groove formed in correspondence to the shape of the screw thread 421, but is not limited thereto.

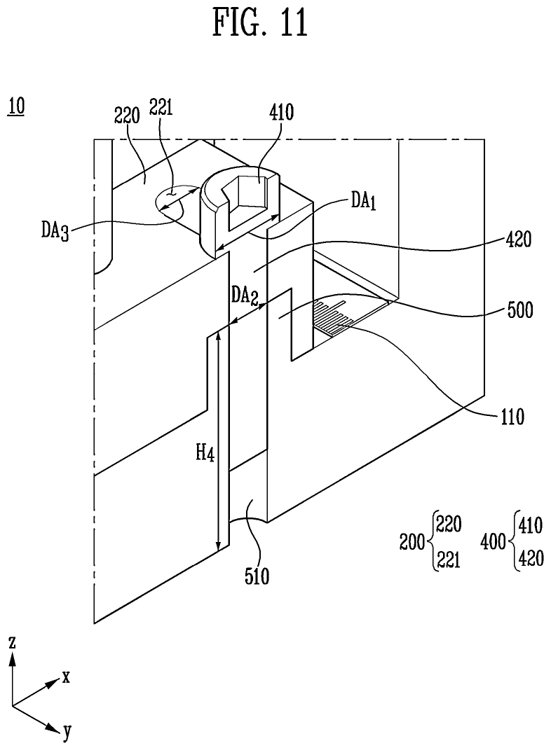

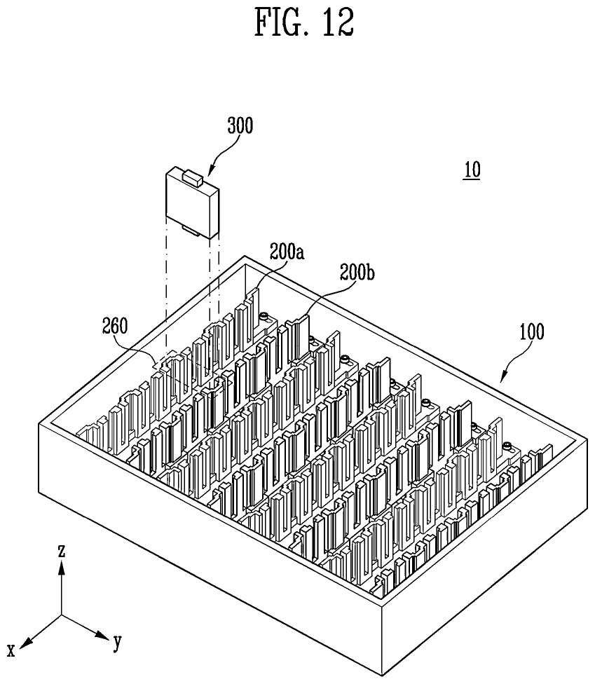

FIG. 10 shows a plan view schematically illustrating at least a part of a battery storage tray 10 according to an embodiment of the present disclosure (XY plane). FIG. 11 shows a perspective view schematically illustrating at least a part of a battery storage tray 10 according to an embodiment of the present disclosure.

Referring to FIG. 10, a battery storage tray 10 according to one aspect of the present disclosure may include a scale bar 110. In addition, the scale bar 110 may be provided in an internal space 100a, and the scale bar 110 may be positioned between an internal coupling portion 500 and an internal wall 100b of an accommodating portion 100.

In addition, referring to FIG. 10, when an insert 200 is housed in an accommodating portion 100, the fastening portion 400 may pass through the through-hole 221 and be coupled to the fastening hole 510. In addition, referring to FIG. 10, a head portion 410 of a fastening portion 400 may not pass through the through-hole 221. Referring to FIG. 11, a fastening insert portion 420 of the fastening portion 400 may pass through the through-hole 221.

In addition, referring to FIG. 10, the width DA₁ of the head portion 410 may be larger than the width DA₃ of the through-hole 221. In addition, referring to FIG. 11, the width DA₁ of the head portion 410 may be larger than the width DA₂ of the fastening insert portion 420 and the width DA₃ of the through-hole 221. In addition, referring to FIG. 11, the width DA₂ of the fastening insert portion 420 may be smaller than or equal to the width DA₃ of the through-hole 221. It may be preferable that the width DA₂ of the fastening insert portion 420 is smaller than the width DA₃ of the through-hole 221.

Meanwhile, referring to FIG. 11, the internal coupling portion 500 may include an area protruding from an internal wall 100b, and may include at least a partial area between an internal wall 100b and an external wall 100c. Specifically, referring to FIG. 11, the fastening hole 510 of the internal coupling portion 500 may be provided in the protruding area. In addition, referring to FIG. 11, the fastening hole 510 may be provided in the protruding area and at least a partial area between an internal wall 100b and an external wall 100c. The fastening hole 510 may pass through or may not pass through between an internal wall 100b and an external wall 100c.

Referring to FIG. 11, the fastening hole 510 may have an appropriate height H₄. When the fastening hole 510 is provided in not only a protruding area of an internal coupling portion 500 but also at least a partial area between an internal wall 100b and an external wall 100c, the height H₄ of the fastening hole 510 may refer to a height throughout the protruding area and at least a partial area between an internal wall 100b and an external wall 100c.

Referring to FIG. 11, the height H₄ of the fastening hole 510 may be smaller than, equal to, or greater than the height H₂ of the fastening portion 400. The relationship between the height H₄ of the fastening hole 510 and the height H₂ of the fastening portion 400 is not particularly limited as long as coupling stability may be secured when an insert 200 is housed in an accommodating portion 100.

Referring to FIGS. 9 and 11, the height H₄ of the fastening hole 510 may be greater than the height H₃ of the fastening insert portion 420. When the relationship between the height H₄ of the fastening hole 510 and the height H₃ of the fastening insert portion 420 is as described above, coupling stability may be secured when an insert 200 is housed in an accommodating portion 100.

Referring to FIG. 11, at least a part of the fastening portion 400 may pass through the through-hole 221. In addition, in another example, only a part of the fastening portion 400 may pass through the through-hole 221. In addition, only a part of the fastening portion 400 may pass through the through-hole 221, and at least a part of the part that has passed through the through-hole 221 may be coupled with the fastening hole 510.

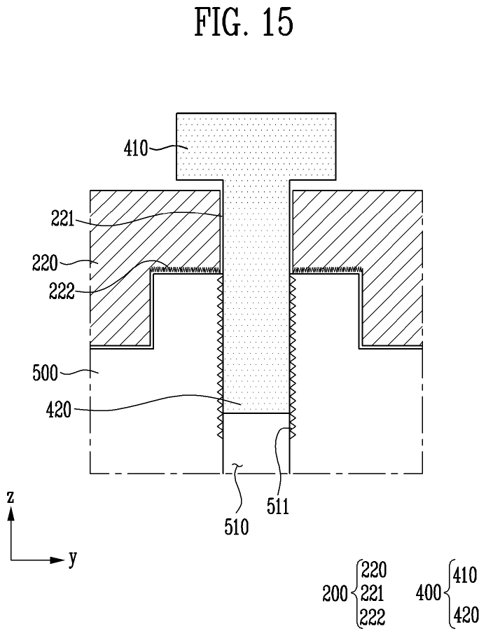

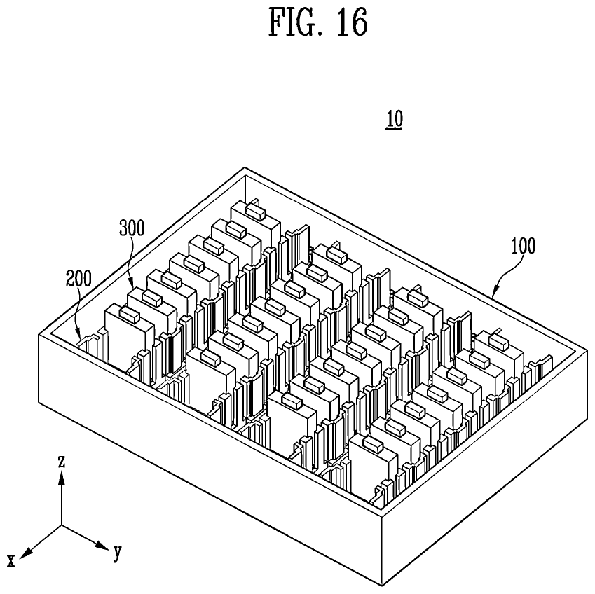

In addition, referring to FIG. 11, the fastening portion 400 may be fastened to a fastening hole 510 to couple the insert 200 and an accommodating portion 100. For example, the fastening portion 400 may be a male screw (bolt), and the fastening hole 510 may have the form of a female screw (nut). The fastening portion 400 may include a screw thread 421 as described above, and at least a part of the fastening hole 510 may include a screw groove 511 (see FIG. 15) corresponding to the shape of the screw thread 421. A part of the fastening portion 400 may be inserted and fastened into the fastening hole 510 to couple the insert 200 and an accommodating portion 100. Meanwhile, at least a part of the fastening hole 510 may include a screw groove 511, and at least a part of a screw thread 421 of the fastening portion 400 may be coupled with the screw groove 511 (see FIG. 15).

In addition, referring to FIGS. 1 and 11, the insert 200 may include one or more insert coupling portions 220 provided at each of both end portions of a supporting body 230, and the insert coupling portion 220 may include a through-hole 221. Each fastening portion 400 may pass through a through-hole 221 of an insert coupling portion 220 provided at both end portions of the supporting body 230, and a fastening portion 400 that has passed through the through-hole 221 may be fastened to a fastening hole 510 of a corresponding internal coupling portion 500, thereby housing the insert 200 in an accommodating portion 100. Conversely, the fastening portion 400 may be removed from the fastening hole 510, thereby separating the insert 200 housed in the accommodating portion 100 from the accommodating portion 100.

Referring to FIGS. 10 and 11, the through-hole 221 may be positioned so that at least a part of a fastening hole 510 of an internal coupling portion 500 is exposed. The fastening portion 400 may pass through the through-hole 221 in the area where the fastening hole 510 is exposed and be coupled with the fastening hole. In other words, the shape of the through-hole 221 may not be limited as long as it allows at least a part of a fastening hole 510 to be exposed. In addition, depending on the shape of the through-hole 221, the distance between inserts 200 may be adjusted according to the position at which a fastening portion 400 passes through the through-hole 221 and is coupled to a fastening hole 510. As a result, a battery storage tray 10 capable of supporting various types (multiple types) or sizes of battery cells 300 and implementing an area in which battery cells 300 are stored through a convenient assembly method can be provided.

FIG. 12 shows a perspective view schematically illustrating at least a part of a battery storage tray 10 according to an embodiment of the present disclosure. Specifically, FIG. 12 shows a diagram illustrating an insert 200 of FIG. 1 housed in an accommodating portion 100.

Referring to FIGS. 1 and 12, in a battery storage tray 10 according to one aspect of the present disclosure, there may be a plurality of inserts 200. In other words, the battery storage tray 10 may include a plurality of inserts 200.

Referring to FIG. 12, an accommodating portion 100 and a plurality of inserts 200 are coupled to each other, and as will be described later, a battery storage portion 260 in which battery cells 300 may be stored may be provided by the inserts 200 coupled with the accommodating portion 100. The size of the battery storage portion 260 may be determined according to the size of a storage groove 210 of an insert 200, and this size may be designed in consideration of the size of the battery cells 300. The battery storage portion 260 may be provided in one or a plural number, and may store as many battery cells 300 as the number of the battery storage portions 260.

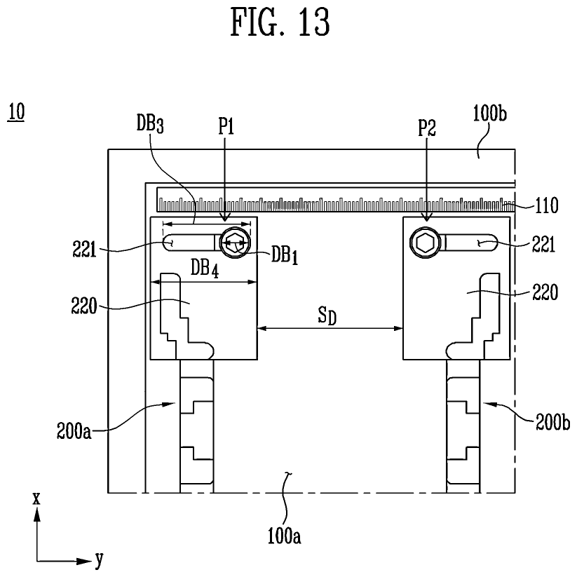

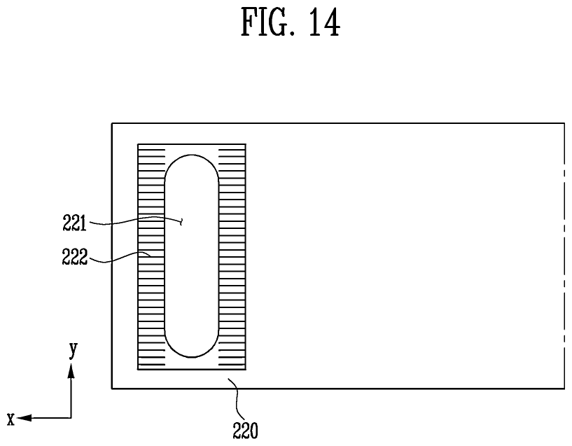

FIG. 13 shows a plan view schematically illustrating at least a part of a battery storage tray 10 according to an embodiment of the present disclosure (XY plane). Referring to FIG. 13, as described above, the battery storage tray 10 may include a plurality of inserts 200. Here, the plurality of inserts 200 may each be coupled with an internal coupling portion 500 through a fastening portion 400.

Meanwhile, referring to FIG. 1, at least a part of adjacent inserts 200 among a plurality of inserts 200 coupled with an internal coupling portion 500 through the fastening portion 400 may or may not have a gap therebetween. In other words, at least a part of the adjacent inserts 200 among the plurality of inserts 200 may be in contact with each other at least partially or may not be in contact with each other. However, there may be a minimum gap between the inserts 200 in order to minimize quality problems due to injection tolerances occurring in an injection process or the like.

Referring to FIG. 13, the breadth DB₁ of a head portion 410 of a fastening portion 400 may be smaller than the breadth DB₃ of a through-hole 221. In this way, when the breadth DB₁ of the head portion 410 is selected to satisfy the above conditions, a battery storage tray 10 capable of supporting various types (multiple types) or sizes of battery cells 300 and implementing an area in which battery cells 300 are stored through a convenient assembly method can be provided.

In addition, referring to FIG. 13, the breadth DB₃ of the through-hole 221 may be designed within an appropriate range compared to the breadth DB₄ of the insert coupling portion 220. When the breadth DB₃ of the through-hole 221 and the breadth DB₄ of the insert coupling portion 220 are designed in an appropriate ratio, it may be advantageous to improve the efficiency of housing of an insert 200 while maintaining mechanical rigidity. In particular, the breadth DB₃ of the through-hole 221 and the breadth DB₄ of the insert coupling portion 220 may be designed to have a ratio applicable to an injection process.

Referring to FIGS. 12 and 13, in a battery storage tray 10 according to one aspect of the present disclosure, an insert 200 may be provided across an internal space 100a of an accommodating portion 100. In addition, the insert 200 may be provided across an internal space 100a of an accommodating portion 100 in a specific direction. Referring to FIG. 13, the insert 200 may be provided across an internal space 100a in the X-axis direction.

Referring to FIGS. 12 and 13, a battery storage tray 10 according to one aspect of the present disclosure may include a plurality of inserts 200. In addition, at least two of the plurality of inserts 200 may be provided across an internal space 100a of an accommodating portion 100 in the same direction. In addition, specifically, the plurality of inserts 200 may all be provided across an internal space 100a of an accommodating portion 100 in the same direction. When the plurality of inserts 200 are all provided in the same direction, a battery storage tray 10 may utilize space efficiently and may be advantageous in storing more battery cells 300.

In addition, referring to FIG. 13, when a plurality of inserts 200 are coupled, the at least two inserts 200 may have a symmetrical structure. For example, referring to FIGS. 12 and 13, two inserts 200, each coupled with an internal coupling portion 500 through a fastening portion 400, may have a structure that is symmetrical to each other about the X-axis. In this way, when at least two inserts 200 among a plurality of inserts 200 have a structure that is symmetrical to each other, a battery storage tray 10 may be provided with the above-described battery storage portion 260.

Referring to FIGS. 12 and 13, in a battery storage tray 10 according to one aspect of the present disclosure, a plurality of inserts 200 may include a first insert 200a and a second insert 200b. In addition, the first insert 200a and the second insert 200b may have a symmetrical structure and be positioned adjacent to each other. Here, the ordinal numbers written in front of the first insert 200a and the second insert 200b are simply added for distinction, regardless of the order or importance. In addition, the above-described battery storage portion 260 may be provided by the first insert 200a and the second insert 200b. In other words, the first insert 200a and the second insert 200b may refer to two adjacent inserts 200 that allow a battery storage portion 260 to be provided.

In addition, the first insert 200a and the second insert 200b having a structure symmetrical to each other means that at the center between the first insert 200a and the second insert 200b, the first insert 200b and the second insert 200b are symmetrical about the direction across an internal space 100a. In addition, the first insert 200a and the second insert 200b being adjacent to each other may mean that there is no other insert 200 between the first insert 200a and the second insert 200b.

Referring to FIG. 12, a battery storage tray 10 according to one aspect of the present disclosure may include a plurality of inserts 200. In addition, the plurality of inserts 200 may be provided so that at least two or all of them may cross an internal space 100a of an accommodating portion.

In addition, referring to FIG. 12, in a battery storage tray 10 according to one aspect of the present disclosure, all inserts may be provided across an internal space 100a of an accommodating portion 100 in the X-direction, and a first insert 200a and a second insert 200b, which are a part thereof, may have a structure that is symmetrical to each other and be positioned adjacently.

Meanwhile, referring to FIG. 13, the first insert 200a and the second insert 200b may be spaced apart. In addition, the spaced distance Sp between the first insert 200a and the second insert 200b may be determined by the position P₁ of a fastening portion 400 passing through a through-hole 221 of a first insert 200a and the position P₂ of a fastening portion 400 passing through a through-hole 221 of a second insert 200b. Specifically, referring to FIG. 13, the position P₁ of the fastening portion 400 passing through the through-hole 221 of the first insert 200a may be such that a fastening insert portion 420 of the fastening portion 400 is the rightmost side (+Y direction) of the through-hole 221 that may be inserted into a fastening hole 510. In addition, referring to FIG. 13, the position P₂ of the fastening portion 400 passing through the through-hole 221 of the second insert 200b may be such that a fastening insert portion 420 of the fastening portion 400 is the leftmost side (−Y direction) of the through-hole 221 that may be inserted into a fastening hole 510. In the case of FIG. 13, this may mean that the spaced distance Sp between the first insert 200a and the second insert 200b is the maximum. In other words, in the case of FIG. 13, when the size of battery cells 300 to be stored is relatively large, the spaced distance SD between a first insert 200a and a second insert 200b may be controlled in this way to accommodating the battery cells 300.

In addition, in another example, the position P₁ of a fastening portion 400 passing through a through-hole 221 of the first insert 200a may be such that a fastening insert portion 420 of the fastening portion 400 is the leftmost side (−Y direction) of the through-hole 221 that may be inserted into a fastening hole 510. In addition, the position P₂ of the fastening portion 400 passing through the through-hole 221 of the second insert 200b may be such that a fastening insert portion 420 of the fastening portion 400 is the rightmost side (+Y direction) of the through-hole 221 that may be inserted into a fastening hole 510. In this case, this may mean that the spaced distance Sp between the first insert 200a and the second insert 200b is the minimum.

As such, the present disclosure may provide a battery storage tray 10 capable of supporting various types (multiple types) or sizes of battery cells 300 through the spaced distance Sp between the first insert 200a and the second insert 200b or the position P₁ of a fastening portion 400 passing through a through-hole 221 of the first insert 200a and the position P₂ of the fastening portion 400 passing through the through-hole 221 of the second insert 200b.

The spaced distance Sp itself may refer to the shortest distance between each insert coupling portion 220 included in the first insert 200a and the second insert 200b. For example, the shortest distance between each of insert coupling portions 220 included in the first insert 200a and the second insert 200b may be determined by a line segment that is perpendicular to each of the insert coupling portion 220 by the position P₁ of a fastening portion 400 passing through a through-hole 221 of the first insert 200a and the insert coupling portion 220 by the position P₂ of the fastening portion 400 passing through the through-hole 221 of the second insert 200b and has a minimum length.

Meanwhile, referring to FIGS. 4 and 12, a battery storage tray 10 according to one aspect of the present disclosure may include a battery storage portion 260 in which battery cells may be stored between a first insert 200a and a second insert 200b. The battery storage portion 260 may be positioned in an area where a storage groove 210 of the first insert 200a and a storage groove 210 of the second insert 200b face each other. In other words, the battery storage tray 10 may include a battery storage portion 260 in which battery cell 300s are stored between a storage groove 210 of a first insert 200a and a storage groove 210 of a second insert 200b.

In addition, referring to FIGS. 4 and 12, a battery storage portion 260 may be positioned in an area where a storage groove 210 provided in a first storage frame portion 240a of a first insert 200a and a storage groove 210 provided in a first storage frame portion 240a of a second insert 200b face each other. In addition, referring to FIGS. 4 and 12, a battery storage portion 260 may be positioned in an area where a storage groove 210 provided in a second storage frame portion 240b of a first insert 200a and a storage groove 210 provided in a second storage frame portion 240b of a second insert 200b face each other.

In addition, referring to FIGS. 4, 12, and 13, a battery storage portion 260 provided by each storage groove 210 of the first insert 200a and the second insert 200b may have different widths and breadths depending on the appropriate structural design of each of the inserts 200, the positions of two inserts 200a and 200b positioned adjacent to each other while having a symmetrical structure, or the like. In other words, through changes in the structural design and coupling position of the inserts 200, a battery storage tray 10 may include a battery storage portion 260 having width and breadth suitable for battery cells 300 to be stored.

FIG. 14 shows a plan view schematically illustrating at least a part of an insert 200 of a battery storage tray 10 according to an embodiment of the present disclosure (XY plane). Specifically, FIG. 14 shows a plan view illustrating a contact surface of an insert coupling portion 220 with an internal coupling portion 500. FIG. 15 shows a plan view schematically illustrating at least a part of a battery storage tray 10 according to an embodiment of the present disclosure (YZ plane).

Referring to FIG. 14, the insert coupling portion 220 may include a knurled portion 222 on a contact surface with the internal coupling portion 500. The knurled portion 222 may refer to a knurled area in an insert coupling portion 220. By increasing the friction between an insert coupling portion 220 and an internal coupling portion 500 through the knurled portion 222, more coupling stability may be ensured when an insert 200 is housed in an accommodating portion 100.

In addition, referring to FIG. 14, the knurled portion 222 may surround a through-hole 221. Through this, the knurled area may be minimized to increase friction between an insert coupling portion 220 and an internal coupling portion 500 while improving process efficiency. The shape of the knurled portion 222 surrounding the through-hole 221 is not particularly limited.

Referring to FIG. 15, the knurled portion 222 surrounds a through-hole 221, and the knurled portion 222 increases friction between an insert coupling portion 220 and an internal coupling portion 500 to ensure more coupling stability when an insert 200 is housed in an accommodating portion 100. In addition, referring to FIG. 15, the fastening portion 400 may include a screw thread 421, and may be fastened to a fastening hole 510. In addition, at least a part of the fastening hole 510 may include a corresponding screw groove 511 according to the shape of the screw thread 421, and a part of the fastening portion 400 (at least a part where a screw thread 421 is formed) may be inserted and fastened into the fastening hole 510. In addition, in a part of the fastening portion 400, at least a part of the screw thread 421 may be coupled with at least a part of the screw groove 511.

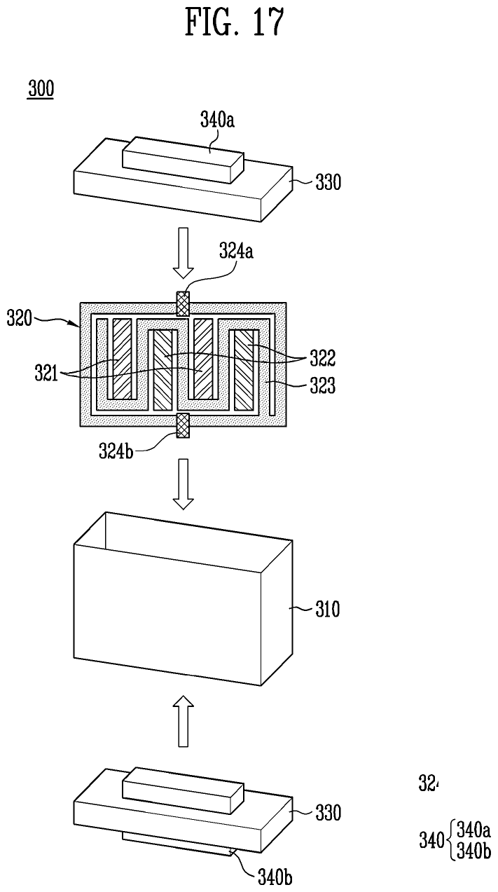

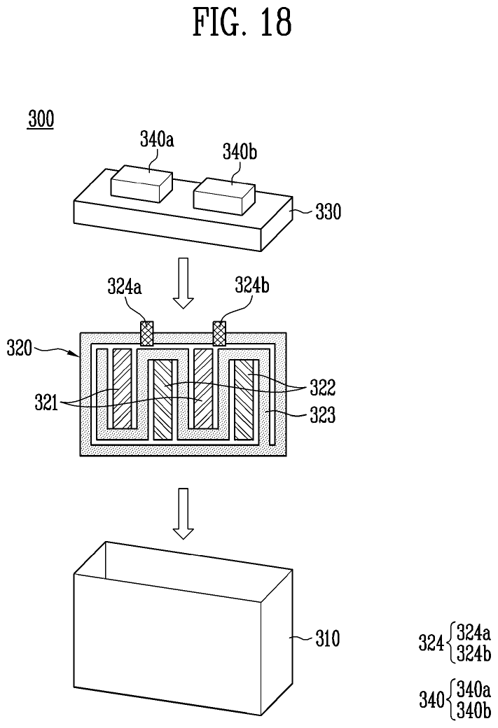

FIG. 16 shows a perspective view schematically illustrating at least a part of a battery storage tray 10 according to an embodiment of the present disclosure. Referring to FIG. 16, it can be confirmed that battery cells 300 are all stored in a battery storage portion 260. The battery cells 300 may include an exterior material 310 capable of housing an electrode assembly 320. In addition, the battery cells 300 may include one or more terminals 340 electrically connected to the electrode assembly 320 and protruding in one direction of the exterior material 310 in a direction that does not face an internal space 100a of an accommodating portion 100 (see FIGS. 17 and 18). In other words, in FIG. 16, the battery cells 300 may be stored in a battery storage portion 260 so that at least some of the terminals 340 of the battery cells 300 protrude in the +Z direction. When a terminal 340 is protruded as described above, charging and discharging or inspection that may be performed in an activation process may be performed more easily. For example, when a probe used for charging and discharging or inspection is in contact with a protruding terminal 340, charging and discharging or inspection that may be performed in an activation process may be performed more easily. Details regarding the battery cells 300 will be described later.

Referring to FIG. 16, the shape of a battery storage portion 260 may be determined by the shape of an exterior material 310 of battery cells 300 to be stored. Referring to FIG. 16, when the shape of an exterior material 310 of battery cells 300 is a prismatic hexahedron, the battery storage portion 260 may have an appropriate shape so that the prismatic hexahedron may be stored, and to this end, a storage frame portion 240 or a frame member 250 of an insert 200 may be appropriately designed.

In addition, battery cells 300 stored in a battery storage portion 260 according to one aspect of the present disclosure may be stored in one direction. The direction may be based on the breadth direction of the battery storage portion 260. In other words, referring to FIG. 16, battery cells 300 stored in a battery storage portion 260 may be said to be stored along the Y-axis direction, which is the breadth direction of the battery storage portion 260.

FIGS. 17 and 18 show exploded perspective views schematically illustrating the structure of a battery cell 300 to be stored in a battery storage tray 10 according to an embodiment of the present disclosure.

The structure of a battery cell 300 according to one aspect of the present disclosure may be a known structure. The battery cell 300 may have a structure in which an electrode assembly 320 is housed in an exterior material 310 which is filled with an electrolyte solution. In another example, the battery cell 300 may include electrodes (cathode 321 and anode 322) and a solid electrolyte layer, and the solid electrolyte layer may have functions of a separator 323 while allowing an electron transport material to pass therethrough. Here, the electron transport material may be a lithium ion (Li⁺). In addition, a battery cell 300 including the solid electrolyte layer may be referred to as an all-solid battery.

The electrode assembly 320 may include an electrode. The term electrode may encompass a cathode 321 and an anode 322. In addition, the electrode assembly 320 may include a separator 323 to prevent short circuit between a cathode 321 and an anode 322. The separator 323 may be interposed between a cathode 321 and an anode 322.

The electrode assembly 320 may be manufactured by winding a cathode 321, an anode 322, and a separator 323 in the form of a vertically long sheet. Alternatively, the electrode assembly 320 may be manufactured by a stacking method (for example, Z-stacking method) in which cathodes 321 and anodes 322 that are cut into an appropriate size are inserted between separators 323 in the form of a vertically long sheet. FIGS. 17 and 18 show an electrode assembly 320 manufactured according to a stacking method, and the manufacturing method of the electrode assembly 320 in the present disclosure is not limited to any one method.

The cathode 321 may refer to a reduction electrode through which an electron transport material receives electrons when a battery cell 300 is discharged. The anode 322 refers to an oxidation electrode through which an electron transport material transports electrons when a battery cell 300 is discharged. In addition, the separator 323 refers to a membrane through which an electron transport material passes while preventing an electrical short circuit between a cathode 321 and an anode 322. Here, the electron transport material may be a lithium ion (Li⁺).

In addition, the battery cell 300 may have a structure in which the electrode assembly 320 is housed into a space sealed with an exterior material 310 which is filled with an electrolyte solution. The term ‘seal space’ used in the present specification refers to a space closed to an extent that when there is a liquid material in the space, the liquid material does not leak to the outside.

The electrolyte solution refers to a medium that causes the movement of an electron transport material (e.g., a lithium ion) to facilitate an electrochemical reaction between a cathode 321 and an anode 322. The electrolyte solution generally includes an organic solvent and a lithium salt, and the organic solvent and lithium salt may include those known in the art.

In the above, batteries are classified into various types depending on the type of the electron transport material. For example, when the electron transport material is lithium (Li, including ions), the battery is referred to as a lithium ion battery.

In addition, as described above, the exterior material 310 may protect the electrode assembly 320 from external shock and prevent (i.e., seal) an electrolyte solution from leaking to the outside. Depending on the shape of the exterior material 310, battery cells 300 may be classified into a prismatic type, a cylindrical type, or a pouch type. In the present disclosure, it may be advantageous for the battery cell 300 to be a prismatic battery cell 300.

In a battery cell 300 according to one aspect of the present disclosure, the electrode assembly 320 may include a tab 324. The tab 324 may include a cathode tab 324a electrically connected to a cathode 321 and an anode tab 324b electrically connected to an anode 322. The tab 324 may protrude from an electrode assembly 320 on at least one surface.

Referring to FIG. 17, a cathode tab 324a and an anode tab 324b may protrude in different directions. A tab 324 in this case may be referred to as a bidirectional tab 324. In addition, referring to FIG. 18, a cathode tab 324a and an anode tab 324b may protrude in the same direction. A tab 324 in this case may be referred to as a unidirectional tab 324.

A battery cell 300 according to one aspect of the present disclosure may include a cap 330 including a terminal 340. The cap 330 may seal an open face for housing an electrode assembly or the like 320 in an exterior material 310 of a battery cell 300. In addition, a terminal 340 included in the cap 330 may be electrically connected to a tab 324 of an electrode assembly 320 by welding or the like, and the terminal 340 may protrude from at least one surface of the cap 330. The cap 330 may be sealed by being coupled with an exterior material 310, and the coupling may generally be performed by welding. When the cap 330 and the exterior material 310 are coupled, a terminal 340 may protrude from an exterior material 310 in one direction.

In addition, referring to FIGS. 17 and 18, a cathode tab 324a may be electrically connected to a cathode terminal 340a, and an anode tab 324b may be electrically connected to an anode terminal 340b. Referring to FIG. 17, a cathode terminal 340a and an anode terminal 340b protrude in different directions. A battery cell 300 in this case may be referred to as a bidirectional battery cell 300. In addition, referring to FIG. 18, a cathode terminal 340a and an anode terminal 340b protrude in the same direction. A battery cell 300 in this case may be referred to as a unidirectional battery cell 300.

The content described above is merely an example of applying the principles of the present disclosure, and other components may be further included without departing from the scope of the present disclosure.

What is claimed is:

1. A battery storage tray comprising an accommodating portion, an insert, and a fastening portion,
wherein the accommodating portion includes an internal space housing the insert and one or more coupling portions provided in the internal space, the internal coupling portion including a fastening hole,
the insert includes an insert coupling portion provided with a storage groove and a through-hole, and
the fastening portion passes through the through-hole and is coupled with the fastening hole.

2. The battery storage tray according to claim 1, wherein the internal coupling portion is spaced apart from an internal wall of the accommodating portion by a predetermined gap.

3. The battery storage tray according to claim 1, wherein the accommodating portion includes a plurality of internal coupling portions, and at least two of the plurality of internal coupling portions are disposed in parallel.

4. The battery storage tray according to claim 3, wherein adjacent internal coupling portions among the internal coupling portions disposed in parallel are each spaced apart by a predetermined gap.

5. The battery storage tray according to claim 3, wherein the internal coupling portions disposed in parallel include a first internal coupling portion group provided along a first line and a second internal coupling portion group provided along a second line.

6. The battery storage tray according to claim 5, wherein the first line and the second line are parallel.

7. The battery storage tray according to claim 5, wherein the first internal coupling portion group and the second internal coupling portion group each independently include a plurality of internal coupling portions.

8. The battery storage tray according to claim 1, further comprising a scale bar provided in the internal space, wherein the scale bar is positioned between an internal coupling portion and an internal wall of an accommodating portion.

9. The battery storage tray according to claim 1, wherein the insert further includes a storage frame portion including a supporting body and a frame member positioned on the supporting body, wherein the supporting body is connected to the insert coupling portion, and the storage frame portion is provided with a storage hole.

10. The battery storage tray according to claim 1, wherein the insert coupling portion is in contact with at least a part of the internal coupling portion, the insert coupling portion further including a knurled portion on a contact surface with the internal coupling portion.

11. The battery storage tray according to claim 10, wherein the knurled portion surrounds a through-hole.

12. The battery storage tray according to claim 9, wherein the insert includes a plurality of insert coupling portions, and one or more of the insert coupling portions are provided at each of both end portions of the supporting portion.

13. The battery storage tray according to claim 1, wherein the insert is provided in a plural number, and the plurality of inserts are provided all in the same direction across the internal space.

14. The battery storage tray according to claim 13, wherein the insert includes a first insert and a second insert, and the first insert and the second insert have a symmetrical structure and are positioned adjacently.

15. The battery storage tray according to claim 14, comprising a storage portion in which a battery cell is stored between a storage groove of the first insert and a storage group of the second insert.

16. The battery storage tray according to claim 14, wherein the first insert and the second insert are spaced apart, and the spaced distance is determined by a position P₁ of a fastening portion passing through a through-hole of the first insert and a position P₂ of a fastening portion passing through a through-hole of the second insert.

17. The battery storage tray according to claim 1, wherein the fastening portion includes a head portion and a fastening insert portion, and the head portion does not pass through the through-hole and the fastening insert portion passes through the through-hole.

18. The battery storage tray according to claim 17, wherein the width DA₁ of the head portion is larger than the width DA₂ of the fastening insert portion and the width DA₃ of the through-hole, and the width DA₂ of the fastening insert portion is smaller than or equal to the width DA₃ of the through-hole.

19. The battery storage tray according to claim 17, wherein the breadth DB₁ of the head portion is smaller than the breadth DB₃ of the through hole.

20. The battery storage tray according to claim 17, wherein the height H₄ of the fastening hole is greater than that of the height H₃ of the fastening insert portion.
